(19) United States
(12) Patent Application Publication
(10) Pub. No.: US 2005/0046218 A1
(43) Pub. Date: Mar. 3, 2005

(54) DASHMAT WITH COMPONENT BRIDGE

(76) Inventor: Michael T. Campbell, Grand Rapids, MI (US)

Correspondence Address: MCGARRY BAIR PC, 171 MONROE AVENUE, N.W., SUITE 600, GRAND RAPIDS, MI, 49503, US

(21) Appl. No.: 10/711,123

(22) Filed: Aug. 25, 2004

Related U.S. Application Data
(60) Provisional application No. 60/481,285, filed on Aug. 25, 2003.

(51) Int. Cl. B62D 33/00

(52) U.S. Cl. 296/39.3

(57) ABSTRACT

The invention comprises a component bridge to reduce the amount of noise entering a passenger compartment of a vehicle through openings in a firewall through which conduits extend. In particular, the component bridge extends from a dashmat to a vehicle component casing to envelop the space around a conduit passing from the engine compartment through the firewall to the component casing.

### CROSS-REFERENCE TO RELATED APPLICATION

This application claims the benefit of U.S. provisional application Ser. No. 60/481,285, filed Aug. 25, 2003, which is incorporated herein by reference in its entirety.

### FIELD OF THE INVENTION

This invention relates to an acoustic barrier for use with a vehicle dashmat. In one of its aspects, the invention relates to an improved acoustic seal for reducing transmission of noise through an opening in the vehicle firewall and the dashmat and from the engine compartment of a vehicle into the passenger compartment. In another of its aspects, the invention relates to a dashmat having an improved acoustic seal for an opening in the dashmat.

### DESCRIPTION OF THE RELATED ART

Motor vehicles have a steel firewall between the engine compartment and the passenger compartment. It has been a common practice in the automotive industry to employ an acoustic barrier system between the firewall and the passenger compartment of the vehicle to reduce noise from the engine compartment into the passenger compartment. The acoustic barrier system generally comprises a noise reducing dashmat along the passenger compartment side of the steel wall. The dashmat generally comprises a relatively dense, resilient barrier layer which reflects sound back toward its source, and a foam or fiber sound-absorbing material intermediate the firewall and the barrier layer.

Various components can be installed in the passenger compartment over the dashmat. Openings through the firewall and dashmat are provided for conduits used to convey fluids and/or electrical power to and from the components. Foam seals and/or flexible boots extend around the openings between the conduits and the firewall to reduce the amount of noise entering the passenger compartment and to prevent water or other materials from entering the passenger compartment. However, the primary purpose of the seal or boot is to provide moisture and debris sealing, with acoustic barrier properties being of secondary importance.

U.S. Pat. No. 5,975,609 to Campbell discloses a dashmat having an integral boot forming an acoustical barrier around a steering column.

U.S. Pat. No. 6,070,928 to Campbell discloses an acoustical barrier comprising a pair of interlocking doors attached to a dashmat which must be secured around the component, thereby requiring additional installation steps.

An acoustic barrier designed to block the transmission of sound through a firewall opening into the passenger compartment is disclosed in U.S. Pat. No. 5,557,078 to Holwerda. Holwerda '078 discloses a dashmat having a pass-through opening circumscribed by an inwardly-extending, flexible, flap-type seal which engages the periphery of a pass-through component.

### SUMMARY OF THE INVENTION

In a motor vehicle comprising a firewall extending between an engine compartment and a passenger compartment, having at least one opening therethrough for passage of a vehicle component. A sound attenuating dashmat is mounted to the passenger compartment side of the firewall and has an opening in registry with the at least one opening in the firewall. A vehicle component passes through the openings in the firewall and the dashmat. A component bridge according to the invention surrounds the openings in the firewall and the dashmat and extends upwardly from an upper surface of the dashmat toward the passenger compartment in cooperative register with at least a portion of a perimeter of the vehicle component and with the dashmat. The component bridge has sound absorbing and sound barrier components to attenuate sound that passes through the openings in the firewall and the dashmat and above the upper surface of the dashmat.

The component bridge is removably attached to the dashmat for selectively installing the component bridge in register with the vehicle component to interrupt the transmission of sound from the engine compartment into the passenger compartment of the motor vehicle, and selectively removing the component bridge from the dashmat when no component is present necessitating the installation of the component bridge. The component bridge is removably attached to the dashmat with a tether. The removable attachment can consist of a tab, a snap, a rivet, a stud, or a strap.

The component bridge further comprises an upwardly extending side wall and a planar top wall of a sound barrier material. The sound barrier material can comprise a plastic, polypropylene, or a thermoplastic olefin. The component bridge can further comprise a sound absorbing material mounted with the side wall and the planar top wall. The sound absorbing material can comprise a low density, porous material, such as an expanded flexible polyurethane, a flexible fibrous material, a non-woven glass fiber mat, or a shoddy cotton.

The sound absorbing material can be bonded to the barrier layer along an inner surface of one of the side wall and the top wall. The component bridge can be in register with at least a perimeter of the vehicle component and with the dashmat.

In a second embodiment, a sound attenuating dashmat is adapted to be mounted to a passenger compartment side of a vehicle firewall, the dashmat having an opening adapted for registry with an opening in the firewall, the vehicle having a vehicle component passing through the opening in the firewall. The dashmat comprises a component bridge surrounding the opening in the dashmat and adapted to extend upwardly from an upper surface of the dashmat toward the passenger compartment in cooperative register with at least a portion of a perimeter of the vehicle component and with the dashmat. The component bridge has sound absorbing and sound barrier components to attenuate sound that passes through the openings in the firewall and the dashmat and above the upper surface of the dashmat when the dashmat is attached to the passenger compartment side of the vehicle firewall.

### BRIEF DESCRIPTION OF THE DRAWINGS

FIG. 1 is an exploded view from the passenger compartment of a motor vehicle of a portion of a firewall overlain by a dashmat, a steering assembly adapted to extend therethrough, and a first embodiment of a component bridge according to the invention.

FIG. 2 is a perspective view of the steering assembly illustrated in FIG. 1 extending through the firewall with the component bridge installed according to the invention.

FIG. 3 is a close-up perspective view of a portion of the firewall overlain by the dashmat illustrated in FIG. 1 with the uninstalled component bridge attached to the dashmat by a connecting strap.

FIG. 4 is a cross-sectional view of a portion of the steering assembly and the component bridge illustrated in FIG. 2 taken along line 4-4.

FIG. 5A is a cross-sectional view of an electrical control module mounted to a firewall and a second embodiment of the component bridge according to the invention prior to installation of the component bridge onto a dashmat.

FIG. 5B is a cross-sectional view similar to FIG. 5A of the electrical control module with the component bridge installed onto a dashmat.

FIG. 6 is a perspective view of the component bridge illustrated in FIGS. 5A and 5B.

### DESCRIPTION OF THE PREFERRED EMBODIMENT

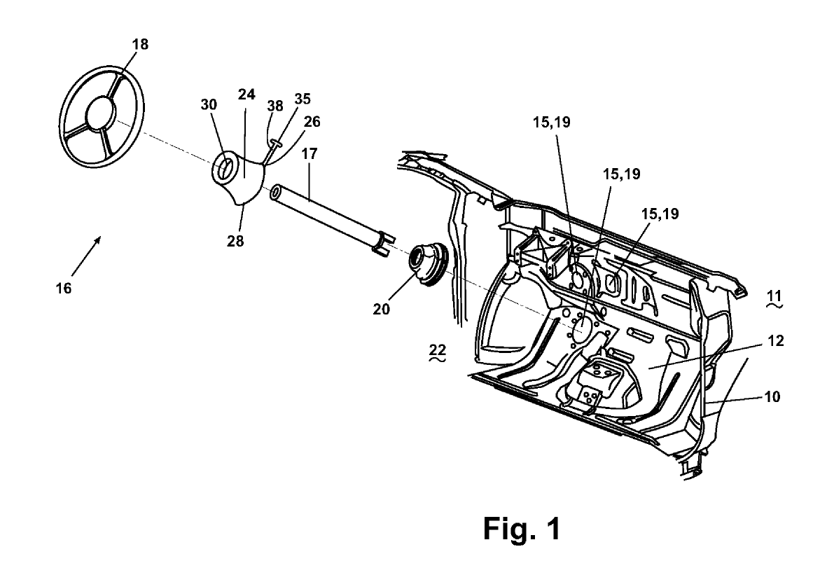

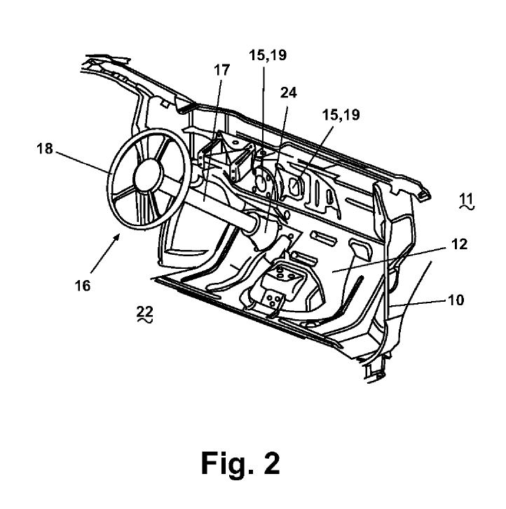

Referring now to the drawings and to FIGS. 1 and 2 in particular, a conventional firewall 10 is illustrated separating an engine compartment 11 from a passenger compartment 22 of a motor vehicle. The view in FIG. 1 is from the passenger compartment 22. It should be noted that the invention is illustrated in the context of a motor vehicle, such as an automobile, for exemplary purposes only, and that the invention is not limited by the examples described herein. In particular, the invention is not limited to use with a two-layer dashmat described herein, but can be used with any dashmat that has both barrier and absorption properties, including single layer firm-flexible foam. An example of a firm flexible foam suitable for a dashmat is described in International Publication No. WO 2004/062966 A2, published Jul. 29, 2004, and entitled “Molded Lightweight Foam Acoustical Barrier And Method Of Making Same,” which is incorporated by reference as though set forth fully herein. In fact, the acoustic seal can be used to attenuate sound through any opening in a substrate, regardless of the nature of the substrate.

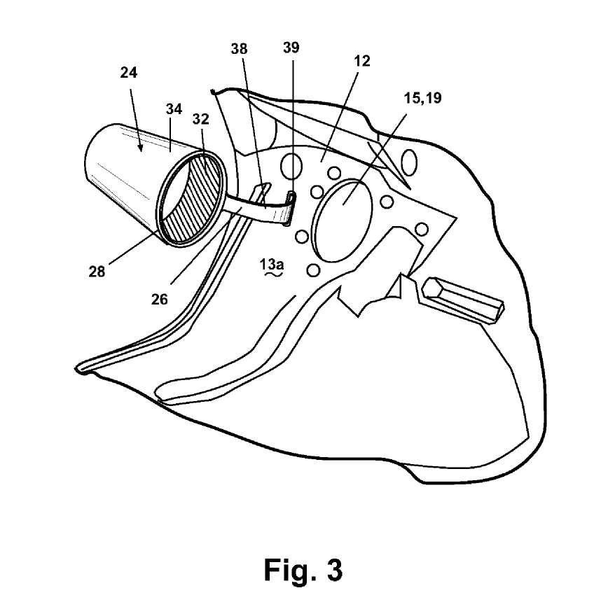

An acoustic barrier, referred to hereinafter as a dashmat 12, is located along the passenger compartment side 22 of the wall 10 and comprises a barrier layer 13 and a sound absorbing layer 14. The barrier layer 13 is typically made of a relatively dense, resilient or flexible synthetic resin, such as a barium sulfate filled polypropylene, a thermoplastic elastomer, elastomer-modified polyurethanes, thermosets such as polyurethanes, or other filled thermoplastic materials, and has an upper surface 13a facing the passenger compartment 22, as illustrated in FIG. 3. The sound absorbing layer 14 is typically a foam plastic material, such as expanded flexible polyurethane, or a flexible fibrous material, such as a nonwoven glass fiber mat, shoddy cotton, or other relatively low density, porous sound-absorbing material that is commonly employed to absorb sound and/or act as a decoupling layer in an acoustic barrier assembly. The sound absorbing layer 14 is typically bonded to the barrier layer 13 so that it is interposed between the barrier layer 13 and the firewall 10 when the dashmat 12 is installed in the motor vehicle. One or more openings 19 are provided through the firewall 10. Openings 15 extending through the barrier layer 13 and the sound absorbing layer 14 are in registry with the openings 19 in the firewall 10 to enable communication between a first component in the passenger compartment 22 and a second component in the engine compartment 11.

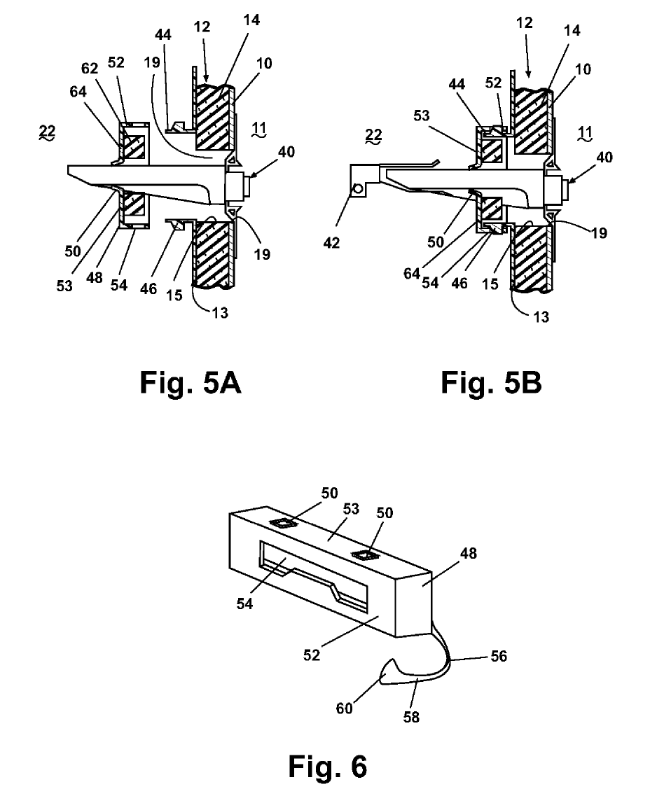

An automotive component, such as an exemplary steering assembly 16, is illustrated in FIGS. 1-4 extending through the firewall 10 and the dashmat 12 in a generally well-known manner. Although an exemplary steering assembly 16 is illustrated in FIGS. 1-4, other automotive components, such as an electrical control module 40 illustrated in FIGS. 5A-6, are frequently mounted along the passenger side of the firewall 10, and the inventive concepts described herein are applicable to such other automotive components in addition to the exemplary steering assembly 16 and electrical control module 40.

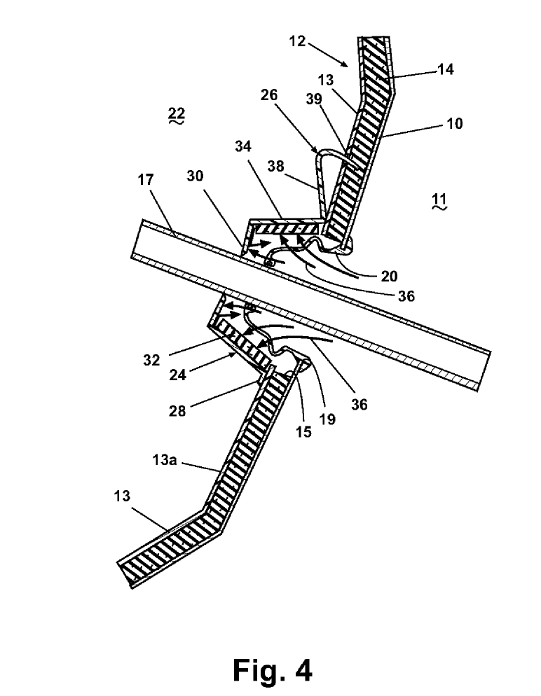

The steering assembly 16 comprises a well-known steering column 17 and a steering wheel 18. As illustrated in FIGS. 1 and 2, the steering column 17 extends through openings 15, 19 in the firewall 12 to link with a steering mechanism in the engine compartment (not shown). In order to prevent moisture and debris from entering from the engine compartment 11 to the passenger compartment 22, and to provide some reduction in noise transmitted from the engine compartment 11 to the passenger compartment 22, a seal, illustrated in FIGS. 1 and 4 as a steering column boot 20 around the steering column 17, is provided for sealing the openings 15, 19 between the steering column 17 and the firewall 10. The boot 20 is typically a thin, flexible rubber material that seals to the steering column 17 by way of an inserted bearing (not shown) of metal or rigid plastic. Noise from the engine compartment 11 can pass through the thin, flexible boot 20, which is a relatively weak acoustic barrier, between the steering column 17 and the dashmat 12, into the passenger compartment 22.

An acoustic seal, comprising a component bridge 24 according to the invention, comprises a regularly or irregularly shaped, thin-shelled body adapted for cooperative register with the steering column 17 and the dashmat 12. Preferably, the component bridge 24 comprises a rigid or semi-rigid outer shell, typically referred to as a barrier layer 34, comprising a polymeric material, such as polypropylene or a thermoplastic olefin, which can be readily formed into a pre-selected shape using conventional plastic forming methods, such as vacuum forming or injection molding. As illustrated in FIGS. 1-4, the component bridge 24 is illustrated as having a generally truncated cone shape having at a first, smaller radius end an aperture 30 adapted for insertion of the steering column 17, and terminating at a second, larger radius end in a perimetric lip 28. However, the component bridge 24 can have any shape suitable for the acoustic sealing function described herein, based upon, for example, the shape of the component to be sealed, the configuration of the adjoining barrier layer surface 13a, space requirements, and the like.

A sound absorbing layer 32, comprising a suitable sound absorbing material, such as expanded flexible polyurethane, or a flexible fibrous material, such as a non-woven glass fiber mat, shoddy cotton, or other relatively low density, porous sound-absorbing material that is commonly employed to absorb sound and/or act as a decoupling layer, can be selectively bonded to the barrier layer 34 to form an annular body along the inner perimeter thereof, as illustrated in FIGS. 3 and 4. It is preferable that the aperture 30 closely circumscribe the steering column 17 to minimize unimpeded sound paths through the aperture 30 along the steering column 17.

In one embodiment, illustrated in FIG. 1, the component bridge 24 is provided with a flexible connecting tether 26 attached at a first end along or proximate to the lip 28. The connecting tether 26 is illustrated as a flexible strap 38 transitioning at its second, free end to an enlarged, somewhat flexible attachment tab 35. The attachment tab 35 can be inserted into a slot 39, illustrated in FIG. 3, or other opening in the barrier layer 13 during fabrication of the dashmat 12 to retain the attachment tab 35 in the slot 39. The flexibility of the attachment tab 35 and its engagement in the slot 39 enables the attachment tab 35 to be removed from the slot 39 by pulling on the connecting tether 26. Alternatively, the tether can have a removable connector, such as a snap, a stud, a breakable rivet, or the like, for attaching the tether to the dashmat 12 until the component bridge 24 is to be installed. The connector is readily separable for removal of the component bridge 24 from the dashmat 12 in preparation for installation of the component bridge 24 with the steering column 17 or other component. Alternatively, the tether 26 can be cut to separate the component bridge 24 from the dashmat 12.

As illustrated in FIGS. 3 and 4, the tether 26 is used to temporarily attach the component bridge 24 to the dashmat 12. The component bridge 24 can be installed to the dashmat 12 around the steering column 17 by first separating the tether 26 from the dashmat 12. Alternatively, as illustrated in FIG. 4, the tether 26 can continue to connect the component bridge 24 to the dashmat 12 if the tether 26 does not impede the installation of the component bridge 24 around the steering column 17.

As illustrated in FIG. 4, the component bridge 24 extends from the steering column 17 to the dashmat 12, thereby interrupting sound transmitted through the openings 15, 19, and preventing its entry into the passenger compartment 22. The sound will be reflected back toward the interior of the component bridge 24 by the barrier layer 34, and also absorbed by the sound absorbing layer 32, as illustrated by the sound vectors 36 of FIG. 4.

The lip 28 is adapted to communicate intimately with the upper surface 13a of the barrier layer 13 in order to enhance the sound blocking capabilities of the component bridge 24. The lip 28 can also provide a means of securing the component bridge 24 against the barrier layer 13 with conventional fasteners, such as threaded or unthreaded studs, snaps, and the like (not shown), or an adhesive applied therealong. The lip 28 can be adapted with a suitable contour for cooperative register with the contour of the dashmat 12. The shape of the component bridge 24 can also be adapted to minimize the space in the passenger compartment 22 occupied by the component bridge 24.

FIGS. 5A-B and 6 show a second embodiment of the component bridge 48 for use with an electrical control module 40. As illustrated in FIG. 5A, the electrical control module 40 is attached to the firewall 10 and extends through the openings 15, 19 beyond the dashmat 12 in conventional fashion. A connector 42 is adapted for electrical communication with the module 40. The dashmat 12 terminates in a raised perimeter wall 44 circumscribing the openings 15, 19 and orthogonal to the dashmat 12. The perimeter wall 44 is provided with a perimeter locking rib 46 extending outwardly along the perimeter of the perimeter wall 44 and spaced somewhat away from the dashmat 12.

The component bridge 48 is illustrated in FIG. 6 as a generally rectilinear thin-shelled body comprising a perimeter wall 52 and a top wall 53, and adapted for operable communication with the perimeter wall 44. Preferably, the component bridge 48 comprises a rigid or semi-rigid plastic barrier layer 64 similar to that described previously herein, and can comprise one or more sound absorbing layers or components 62 (FIGS. 5A and 5B) similar to that described previously herein and adapted to the configuration of the electrical control module 40. The perimeter wall 52 is adapted for fixed, cooperative register with the perimeter locking rib 46 to secure the component bridge 48 to the perimeter wall 44. A perimeter locking slot 54 is illustrated extending through and along a portion of the perimeter wall 52, and adapted for locking communication with the perimeter locking rib 46. Other suitable connecting devices such as snaps, threaded fasteners, friction or interference fit assemblies, and the like can also be utilized to secure the component bridge 48 to the perimeter wall 44. The top wall 53 is provided with apertures 50 to receive the module 40 and/or the connectors 42 therethrough. FIG. 6 illustrates the component bridge 48 with a connecting strap 56 for attaching the component bridge 48 to the dashmat 12, as previously described herein.

During vehicle assembly, the dashmat 12 will be typically installed against the firewall 10, followed at some later time by installation of the steering assembly 16 and/or the electrical control module 40. The steering assembly 16 will be installed by inserting the steering column 17 through the openings 15, 19 with the boot 20 properly positioned to seal the space between the steering column 17 and the openings 15, 19. Similarly, the electrical control module 40 will be installed to the firewall 10 so that the module 40 extends through the openings 15, 19 for attachment of the connectors 42. At some later time, the component bridge 24, 48 can be installed around the steering column 17 and/or the electrical control module 40 and secured to the dashmat 12 and/or the firewall 10 using conventional fasteners, as described above.

The component bridge described herein provides effective blocking and absorption of sound traveling from the engine compartment of a motor vehicle through openings in the firewall associated with vehicle components mounted in the passenger compartment. It is readily fabricated using well-known fabrication processes, and easily installed around the perimeter of the component after installation of the component in the passenger compartment. It can be adapted to closely follow the contour of the component in order to minimize the space occupied by the component bridge. The use of a rigid outer shell with a sound absorbing foam provides effective sound blocking while taking up little additional space. The use of a connecting strap or a removable connecting tab retains the component bridge attached to the dashmat until the component bridge is installed, thereby reducing the number of lost or unavailable parts, and the necessity of maintaining a separate supply of component bridges.

While the invention has been specifically described in connection with certain specific embodiments thereof, it is to be understood that this is by way of illustration and not of limitation. For example, the invention is not limited to use of the acoustic seal with a two layer dashmat but can be used with any dashmat that has both barrier and absorption properties, including single layer firm-flexible foam. In fact, the acoustic seal can be used to attenuate sound through any opening in a substrate, regardless of the nature of the substrate. Reasonable variation and modification are possible within the scope of the foregoing description and drawings without departing from the spirit of the invention.

1. In a motor vehicle comprising a firewall extending between an engine compartment and a passenger compartment, having at least one opening therethrough for passage of a vehicle component, a sound attenuating dashmat mounted to the passenger compartment side of the firewall and having an opening in registry with the at least one opening in the firewall, and a vehicle component passing through the openings in the firewall and the dashmat, the improvement comprising:
a component bridge surrounding the openings in the firewall and the dashmat and extending upwardly from an upper surface of the dashmat toward the passenger compartment in cooperative register with at least a portion of a perimeter of the vehicle component and with the dashmat, the component bridge having sound absorbing and sound barrier components to attenuate sound that passes through the openings in the firewall and the dashmat and above the upper surface of the dashmat.

2. A motor vehicle according to claim 1 wherein the component bridge is removably attached to the dashmat for selectively installing the component bridge in register with the vehicle component to interrupt the transmission of sound from the engine compartment into the passenger compartment of the motor vehicle, and selectively removing the component bridge from the dashmat when no component is present necessitating the installation of the component bridge.

3. A motor vehicle according to claim 1 wherein the component bridge is removably attached to the dashmat with a tether.

4. A motor vehicle according to claim 2 wherein the removable attachment is selected from the group consisting of a tab, a snap, a rivet, and a stud.

5. A motor vehicle according to claim 2 wherein the removable attachment comprises a strap.

6. A motor vehicle according to claim 1 wherein the component bridge further comprises an upwardly extending side wall and a planar top wall of a sound barrier material.

7. A motor vehicle according to claim 6 wherein the sound barrier material comprises a plastic.

8. A motor vehicle according to claim 6 wherein the sound barrier material is selected from the group consisting of polypropylene or a thermoplastic olefin.

9. A motor vehicle according to claim 6 wherein the component bridge further comprises a sound absorbing material mounted with the side wall and the planar top wall.

10. A motor vehicle according to claim 9 wherein the sound absorbing material comprises a low density, porous material.

11. A motor vehicle according to claim 9 wherein the sound absorbing material is selected from the group consisting of an expanded flexible polyurethane, a flexible fibrous material, a non-woven glass fiber mat, and a shoddy cotton.

12. A motor vehicle according to claim 6 wherein the component bridge further comprises a sound absorbing material.

13. A motor vehicle according to claim 12 wherein the sound absorbing material is bonded to the barrier layer along an inner surface of one of the side wall and the top wall.

14. A motor vehicle according to claim 1 wherein the component bridge is in register with at least a perimeter of the vehicle component and with the dashmat.

15. A sound attenuating dashmat adapted to be mounted to a passenger compartment side of a vehicle firewall, the dashmat having an opening adapted for registry with an opening in the firewall, the vehicle having a vehicle component passing through the opening in the firewall, the dashmat comprising:
a component bridge surrounding the opening in the dashmat and adapted to extend upwardly from an upper surface of the dashmat toward the passenger compartment in cooperative register with at least a portion of a perimeter of the vehicle component and with the dashmat, the component bridge having sound absorbing and sound barrier components to attenuate sound that passes through the openings in the firewall and the dashmat and above the upper surface of the dashmat when the dashmat is attached to the passenger compartment side of the vehicle firewall.

16. A sound attenuating dashmat according to claim 15 wherein the component bridge is removably attached to the dashmat to enable the selective installation of the component bridge in register with the vehicle component to interrupt the transmission of sound from the engine compartment into the passenger compartment of the motor vehicle, and the selective removal of the component bridge from the dashmat when no component is present necessitating the installation of the component bridge.

17. A sound attenuating dashmat according to claim 15 wherein the component bridge is removably attached to the dashmat with a tether.

18. A sound attenuating dashmat according to claim 16 wherein the removable attachment is selected from the group consisting of a tab, a snap, a rivet, and a stud.

19. A sound attenuating dashmat according to claim 16 wherein the removable attachment comprises a strap.

20. A sound attenuating dashmat according to claim 15 wherein the component bridge further comprises an upwardly extending side wall and a planar top wall of a sound barrier material.

21. A sound attenuating dashmat according to claim 20 wherein the sound barrier material comprises a plastic.

22. A sound attenuating dashmat according to claim 20 wherein the sound barrier material is selected from the group consisting of polypropylene or a thermoplastic olefin.

23. A sound attenuating dashmat according to claim 20 wherein the component bridge further comprises a sound absorbing material mounted with the side wall and the planar top wall.

24. A sound attenuating dashmat according to claim 23 wherein the sound absorbing material comprises a low density, porous material.

25. A sound attenuating dashmat according to claim 23 wherein the sound absorbing material is selected from the group consisting of an expanded flexible polyurethane, a flexible fibrous material, a non-woven glass fiber mat, and a shoddy cotton.

26. A sound attenuating dashmat according to claim 20 wherein the component bridge further comprises a sound absorbing material.

27. A sound attenuating dashmat according to claim 26 wherein the sound absorbing material is bonded to the barrier layer along an inner surface of one of the side wall and the top wall.

28. A sound attenuating dashmat according to claim 15 wherein the component bridge is adapted for registry with at least a perimeter of the vehicle component and with the dashmat.
